(19) United States
(12) Patent Application Publication
(10) Pub. No.: US 2026/0164355 A1
(43) Pub. Date: Jun. 11, 2026

(54) RECEIVER ADAPTATIONS USING WAKE UP SIGNALS

(71) Applicant: QUALCOMM Incorporated, San Diego, CA (US)

(72) Inventors: Weimin DUAN, San Diego, CA (US); Hyojin LEE, San Diego, CA (US); Gabi SARKIS, San Diego, CA (US)

(21) Appl. No.: 18/974,473

(22) Filed: Dec. 9, 2024

(51) Int. Cl. H04W 52/02; H04W 72/23

(52) U.S. Cl. CPC H04W 52/0235; H04W 72/23

(57) ABSTRACT

Methods, systems, and devices for wireless communications at user equipment (UE) are described. A UE may receive, via a wake up radio (WUR) of the UE, a wake up signal (WUS) indicating a quantity of antennas for the UE to use to monitor for a downlink control channel for the UE. The UE may monitor, using a main radio (MR) of the UE, one or more control channel monitoring occasions (MOs) for the downlink control channel for the UE in accordance with the quantity of antennas indicated by the WUS. The UE may receive, based on monitoring the one or more control channel MOs, downlink control information (DCI) via the downlink control channel for a downlink shared channel for the UE.

### FIELD OF TECHNOLOGY

The following relates to wireless communications at user equipment (UE), including receiver adaptations using wake up signals (WUSs).

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving, via a wake up radio (WUR) of the UE, a wake up signal (WUS) indicating a quantity of antennas for the UE to use to monitor for a downlink control channel for the UE, monitoring, using a main radio (MR) of the UE, one or more control channel monitoring occasions (MOs) for the downlink control channel for the UE in accordance with the quantity of antennas indicated by the WUS, and receiving, based on monitoring the one or more control channel MOs, downlink control information (DCI) via the downlink control channel, where the DCI is for a downlink shared channel for the UE.

A UE for wireless communications is described. The UE may include one or more memories storing processor executable code, and one or more processors coupled with the one or more memories. The one or more processors may individually or collectively be operable to execute the code to cause the UE to receive, via a WUR of the UE, a WUS indicating a quantity of antennas for the UE to use to monitor for a downlink control channel for the UE, monitor, using a MR of the UE, one or more control channel MOs for the downlink control channel for the UE in accordance with the quantity of antennas indicated by the WUS, and receive, based on monitoring the one or more control channel MOs, DCI via the downlink control channel, where the DCI is for a downlink shared channel for the UE.

Another UE for wireless communications is described. The UE may include means for receiving, via a WUR of the UE, a WUS indicating a quantity of antennas for the UE to use to monitor for a downlink control channel for the UE, means for monitoring, using a MR of the UE, one or more control channel MOs for the downlink control channel for the UE in accordance with the quantity of antennas indicated by the WUS, and means for receiving, based on monitoring the one or more control channel MOs, DCI via the downlink control channel, where the DCI is for a downlink shared channel for the UE.

A non-transitory computer-readable medium storing code for wireless communications is described. The code may include instructions executable by one or more processors to receive, via a WUR of the UE, a WUS indicating a quantity of antennas for the UE to use to monitor for a downlink control channel for the UE, monitor, using a MR of the UE, one or more control channel MOs for the downlink control channel for the UE in accordance with the quantity of antennas indicated by the WUS, and receive, based on monitoring the one or more control channel MOs, DCI via the downlink control channel, where the DCI is for a downlink shared channel for the UE.

In some examples of the method, UEs, and non-transitory computer-readable medium described herein may further include operations, features, means, or instructions for switching, based on reception of the WUS and during a switching duration, from operating using a second quantity of antennas to operating using the quantity of antennas.

In some examples of the method, UEs, and non-transitory computer-readable medium described herein, the downlink shared channel may be associated with the quantity of antennas and the downlink control channel may be associated with a second quantity of antennas, and the second quantity of antennas may be less than the quantity of antennas.

Some examples of the method, UEs, and non-transitory computer-readable medium described herein may further include operations, features, means, or instructions for monitoring, using the WUR of the UE and using a second quantity of antennas, for the WUS, where the second quantity of antennas may be less than the quantity of antennas.

Some examples of the method, UEs, and non-transitory computer-readable medium described herein may further include operations, features, means, or instructions for receiving one or more signals indicating a configuration for the WUS, where the configuration indicates that the WUS includes a low power-WUS (LP-WUS), and where one or more bits of the LP-WUS indicate the quantity of antennas.

In some examples of the method, UEs, and non-transitory computer-readable medium described herein, the WUS includes a receiver mode WUS, the receiver mode WUS dedicated for indicating the quantity of antennas.

In some examples of the method, UEs, and non-transitory computer-readable medium described herein, the receiver mode WUS may be associated with a first periodicity and the method, apparatuses, and non-transitory computer-readable medium may include further operations, features, means, or instructions for receiving a LP-WUS associated with a second periodicity, where the second periodicity may be less than the first periodicity.

In some examples of the method, UEs, and non-transitory computer-readable medium described herein, the DCI includes an indication of a second quantity of antennas associated with the downlink shared channel.

In some examples of the method, UEs, and non-transitory computer-readable medium described herein, the second quantity of antennas may be different from the quantity of antennas and the method, apparatuses, and non-transitory computer-readable medium may include further operations, features, means, or instructions for monitoring, using a MR of the UE and based on the DCI, one or more shared channel MOs for the downlink shared channel in accordance with the second quantity of antennas indicated by the DCI.

In some examples of the method, UEs, and non-transitory computer-readable medium described herein, the WUS includes one or more cyclic redundancy check (CRC) bits indicating a switch from a second quantity of antennas to the quantity of antennas, or one or more scrambled CRC bits that indicate the switch from the second quantity of antennas to the quantity of antennas, or any combination thereof.

Some examples of the method, UEs, and non-transitory computer-readable medium described herein may further include operations, features, means, or instructions for determining, based on the one or more CRC bits, the one or more scrambled CRC bits, or any combination thereof, failure of a decoding procedure associated with the WUS and switching, based on the determination, to a second quantity of antennas, the second quantity of antennas greater than the quantity of antennas.

Some examples of the method, UEs, and non-transitory computer-readable medium described herein may further include operations, features, means, or instructions for switching from the quantity of antennas to a second quantity of antennas in accordance with a timer, a detection window, or any combination thereof, where the second quantity of antennas may be less than the quantity of antennas.

Some examples of the method, UEs, and non-transitory computer-readable medium described herein may further include operations, features, means, or instructions for switching from the second quantity of antennas to a third quantity of antennas in accordance with one or more conditions at the UE, where the third quantity of antennas may be greater than the second quantity of antennas and transmitting, in accordance with the switch, an indication that the UE may be to skip one or more MOs for the WUS in accordance with switching to the third quantity of antennas.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIGS. 1 and 2 show examples of wireless communications system that support receiver adaptations using wake up signals (WUSs) in accordance with one or more aspects of the present disclosure.

FIGS. 3 and 4 show examples of timing diagrams that support receiver adaptations using WUSs in accordance with one or more aspects of the present disclosure.

FIG. 5 shows an example of a signal diagram that supports receiver adaptations using WUSs in accordance with one or more aspects of the present disclosure.

FIG. 6 shows an example of a process flow that supports receiver adaptations using WUSs in accordance with one or more aspects of the present disclosure.

FIGS. 7 and 8 show block diagrams of devices that support receiver adaptations using WUSs in accordance with one or more aspects of the present disclosure.

FIG. 9 shows a block diagram of a communications manager that supports receiver adaptations using WUSs in accordance with one or more aspects of the present disclosure.

FIG. 10 shows a diagram of a system including a device that supports receiver adaptations using WUSs in accordance with one or more aspects of the present disclosure.

FIGS. 11 and 12 show flowcharts illustrating methods that support receiver adaptations using WUSs in accordance with one or more aspects of the present disclosure.

### DETAILED DESCRIPTION

In some wireless communication systems, a user equipment (UE) may operate in a power saving mode by operating with a small quantity of antennas (e.g., receivers (Rx), receive chains, transmitters (Tx), transmit chains, radio frequency (RF) chains). For example, the UE may operate with a small quantity of antennas to monitor for a physical downlink control channel (PDCCH), which may be associated with power saving at the UE. The UE may monitor for the PDCCH with the small quantity of antennas (e.g., 1 Rx), which may be a first receiver mode. The UE may shift to using a larger quantity of antennas (e.g., a second receiver mode) when the PDCCH is received, as the UE may use the larger quantity of antennas (e.g., 2 Rx, 4 Rx, 8 Rx) to successfully decode a physical downlink shared channel (PDSCH) scheduled by the PDCCH. However, switching from the small quantity of antennas to the larger quantity of antennas may be associated with some duration. The PDSCH may be transmitted by a network entity before the transition between receiver modes may be completed, resulting in an undecodable PDSCH. This may result in increased latency, reduced power saving, reduced efficiency, and other problems.

A UE may operate in a low power mode by implementing a low power-wake up radio (LP-WUR). A UE operating in a normal mode, while connected to a serving cell, may use a main radio (MR) to communicate. The MR may be associated with high power consumption. To support power saving, the UE may transition into a low power mode and use a LP-WUR for communication. The LP-WUR may receive communications and may not transmit communications. In order to transition from a low power mode to a normal mode, the UE may receive a wake up signal (WUS), or a low power WUS (LP-WUS) with the LP-WUR. Receiving the LP-WUS may trigger the UE to monitor for a PDCCH using the MR. The LP-WUS may be transmitted to the UE to account for the delay in switching between the radios. That is, there may be some duration between when an LP-WUS is received and a PDCCH monitoring occasion (MO) occurs. Although an LP-WUS may indicate to change radios, the LP-WUS may not indicate any information about a receiver mode or a quantity of antennas to use for monitoring and reception of the PDCCH and a subsequent PDSCH.

Various aspects relate generally to wireless communications and more particularly to WUS, such as LP-WUS, and changing quantities of antennas at a UE (e.g., changing receiver modes). Some aspects more specifically relate to receiving a WUS (e.g., LP-WUS) with a LP-WUR, where the WUS indicates a change in a quantity of antennas for monitoring a PDCCH at a UE. That is, the WUS may indicate a quantity of antennas for the UE to use for monitoring and receiving a PDCCH, as well as a related PDSCH. In some examples, the UE may receive the WUS indicating a quantity of antennas. The UE may monitor for a PDCCH with the indicated quantity of antennas. In some examples, the WUS may be an LP-WUS. The LP-WUS may contain one or more bits to indicate the quantity of antennas for monitoring the PDCCH. That is, the LP-WUS may contain an additional one or more bits that may indicate a quantity of antennas, or a receiver mode. Additionally, or alternatively, the WUS may be specific to the quantity of antennas (e.g., a receiver mode WUS). In some examples, the receiver mode WUS may be transmitted at a longer periodicity than an LP-WUS, where the LP-WUS may not include an indication of a quantity of antennas. For example, the UE may operate with the quantity of antennas for some duration that may be longer than the periodicity of the LP-WUS.

In some examples, reliability of the WUS may be increased by including an indication of the quantity of antennas in downlink control information (DCI) received via the PDCCH. If the indication in the DCI is different from the indication in the WUS, the UE may follow the quantity indicated by the DCI. Additionally, or alternatively, the network entity may mask the WUS, such as by designing a cyclic redundancy check (CRC) mask. If the CRC mask indicates that the quantity of antennas indicated in the decoded WUS may not be correct, the UE may default to using a larger quantity of antennas to reduce the risk of PDSCH decoding failure.

Particular aspects of the subject matter described in this disclosure can be implemented to realize one or more of the following potential advantages. By indicating a quantity of antennas to use for PDCCH monitoring and reception, as well as subsequent PDSCH reception, in the WUS, aspects of the present disclosure may increase power saving and reduce latency, among other benefits. For example, including information about a quantity of antennas in a WUS, rather than solely in a PDCCH, may leverage the timing of the WUS. This may allow the UE time to change receiver modes without risking missing reception of a PDSCH. This may reduce latency associated with failure to receive a schedule PDSCH and increase power saving associated with excess signaling and monitoring associated with failing to receive a DPSCH. Additionally, to alternatively, in some examples, the WUS may be received with a receiver mode using a small quantity of antennas (e.g., 1 Rx), which may support power saving at the UE.

Aspects of the disclosure are initially described in the context of wireless communications systems, timing diagrams, signal diagrams, and process flows. Aspects of the disclosure are further illustrated by and described with reference to apparatus diagrams, system diagrams, and flowcharts that relate to receiver adaptations using WUSs.

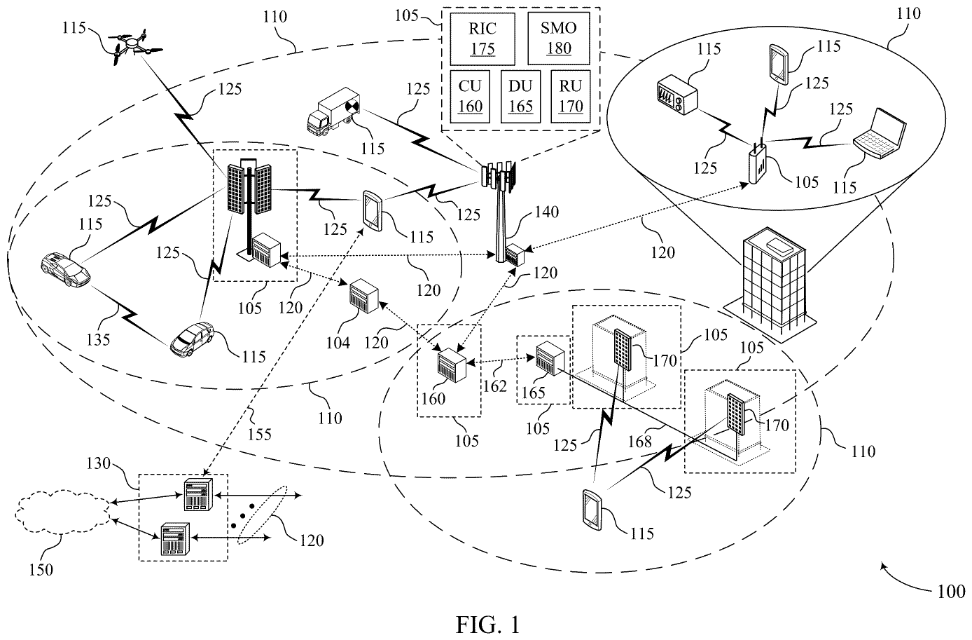

FIG. 1 shows an example of a wireless communications system 100 that supports receiver adaptations using WUSs in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3(L3 ), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1 ) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support receiver adaptations using WUSs as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a CRC), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some wireless communications systems 100, a UE 115 may operate in a power saving mode by operating with a small quantity of antennas (e.g., e.g., receivers, receiving chains, Rx). For example, the UE 115 may operate with a small quantity of antennas to monitor for a PDCCH, which may be associated with power saving at the UE 115. The UE 115 may monitor for the PDCCH with the small quantity of antennas (e.g., 1 Rx), which may be a first receiver mode. The UE 115 may shift to using a larger quantity of antennas (e.g., a second receiver mode) when the PDCCH is received, as a UE 115 may use the larger quantity of antennas (e.g., 2 Rx, 4 Rx, 8 Rx) to successfully decode a PDSCH scheduled by the PDCCH. However, switching from the small quantity of antennas to the larger quantity of antennas may be associated with some duration. The PDSCH may be transmitted by a network entity 105 before the transition between receiver modes may be completed, resulting in an undecodable PDSCH at the UE 115.

The UE 115 may operate in a low power mode by implementing a LP-WUR. The UE 115 operating in a normal mode, while connected to a serving cell, may use a MR to communicate. The MR may be associated with high power consumption. To support power saving, the UE 115 may transition into a low power mode and use the LP-WUR for communication. The LP-WUR may receive communications and may not transmit communications. In order to transition from a low power mode to a normal mode, the UE 115 may receive a WUS, or a LP-WUS, with the LP-WUR. Receiving the LP-WUS may trigger the UE 115 to monitor for a PDCCH using the MR. The LP-WUS may be transmitted to the UE 115 to account for the delay in switching between the radios. That is, there may be some duration between when an LP-WUS is received and a PDCCH MO may occur.

Various aspects relate generally to wireless communications and more particularly to WUS, such as LP-WUS, and changing quantities of antennas at the UE 115 (e.g., changing receiver modes). Some aspects more specifically relate to using a WUS (e.g., LP-WUS) to indicate a change in a quantity of antennas for monitoring a PDCCH at the UE 115. That is, implementing a WUS may indicate a quantity of antennas for the UE 115 to use for monitoring and receiving a PDCCH, as well as a related PDSCH. In some examples, the UE 115 may receive the WUS indicating a quantity of antennas. The UE 115 may monitor for a PDCCH with the indicated quantity of antennas. In some examples, the WUS may be an LP-WUS. The LP-WUS may contain one or more bits to indicate the quantity of antennas for monitoring the PDCCH. That is, the LP-WUS may contain an additional one or more bits that may indicate a quantity of antennas, or a receiver mode. Additionally, or alternatively, the WUS may be specific to the quantity of antennas (e.g., a receiver mode WUS). In some examples, the receiver mode WUS may be transmitted at a longer periodicity than an LP-WUS, where the LP-WUS may not include an indication of a quantity of antennas. For example, the UE 115 may operate with the quantity of antennas for some duration that may be longer than the periodicity of the LP-WUS.

In some examples, reliability of the WUS may be increased by including an indication of the quantity of antennas in DCI received via the PDCCH. If the indication in the DCI is different from the indication in the WUS, the UE 115 may follow the quantity indicated by the DCI. Additionally, or alternatively, the network entity may mask the WUS, such as by designing a CRC mask. If the CRC mask indicates that the quantity of antennas indicated in the decoded WUS may not be correct, the UE 115 may default to using a larger quantity of antennas to reduce the risk of PDSCH decoding failure.

By indicating a quantity of antennas to use for PDCCH monitoring and reception, as well as subsequent PDSCH reception, in a WUS, the wireless communications system 100 may increase power saving at the UE 115 and reduce latency, among other benefits.

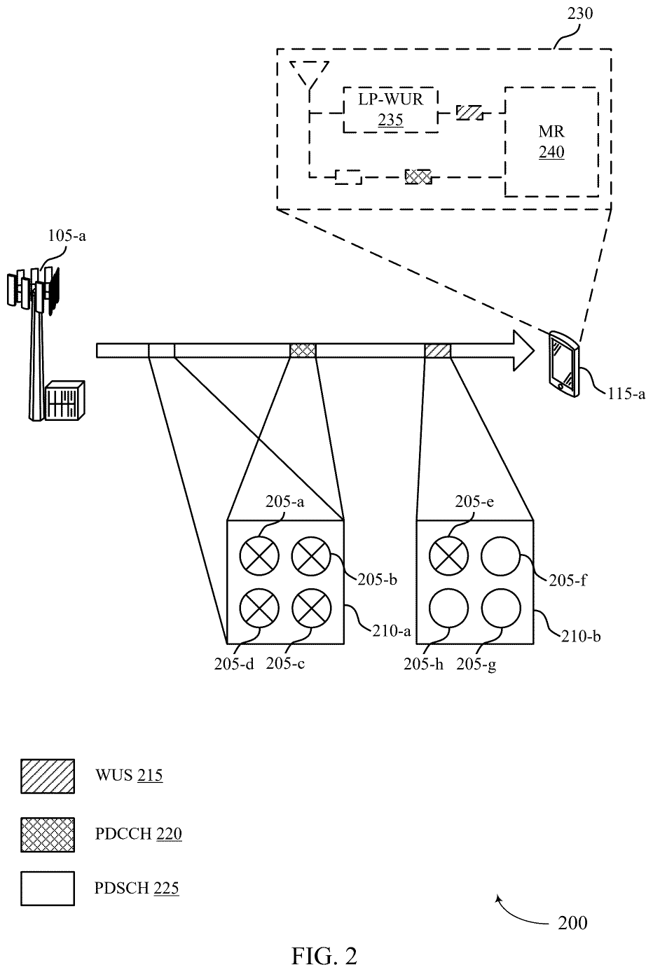

FIG. 2 shows an example of a wireless communications system 200 that supports receiver adaptations using WUSs in accordance with one or more aspects of the present disclosure. The wireless communications system 200 may implement, or be implemented by, aspects of the wireless communications system 100. For example, the wireless communications system 200 may include one or more network entities 105 and UEs 115, including at least the network entity 105-a and the UE 115-a, which may be examples of corresponding devices as described herein, including with reference to FIG. 1. The techniques described herein in the context of the wireless communications system 200 may support the network entity 105-a using a WUS 215 to indicate a change in a quantity of antennas 205 at a UE 115-a associated with a receiver mode 210 for the UE 115-a.

Some wireless communications systems 200 may support a UE 115-a using different quantity of antennas 205 for receiving communications from a network entity 105-a (e.g., operating in different receiver modes). For example, in a receiver mode 210-b, the UE 115-a may receive a WUS 215 using a reduced quantity of antennas 205. In receiver mode 210-b, an antenna 205-e may be active, while antennas 205-f, 205-g, and 205-h may not be active (e.g., 1 Rx mode).

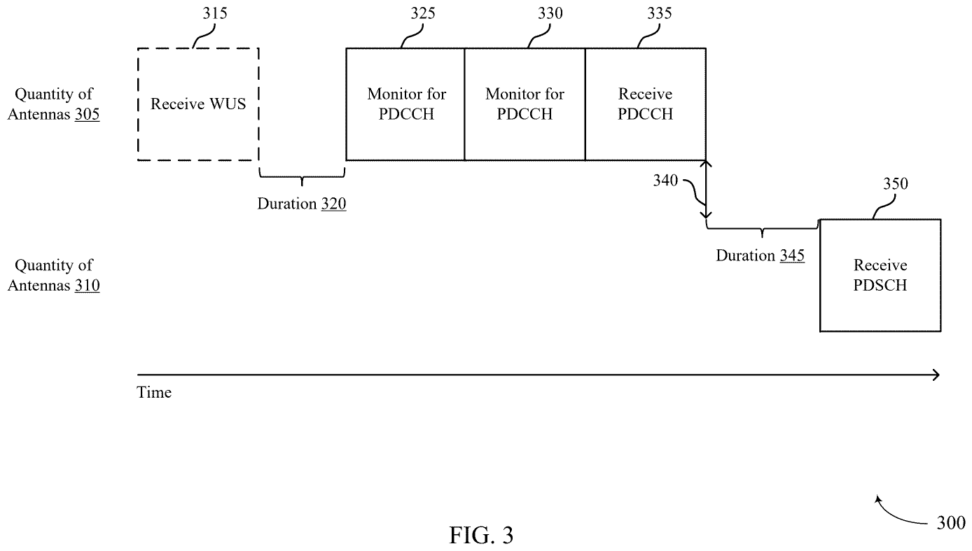

In some implementations, the UE 115-a may monitor for and receive a PDCCH 220 using the receiver mode 210-b, or a power savings mode with a reduced quantity of antennas 205, as described further with reference to FIG. 3. The UE 115-a may receive a PDSCH 225 using an increased quantity of antennas 205, such as in receiver mode 210-a. In receiver mode 210-a, antennas 205-a, 205-b, 205-c, and 205-d may all be active (e.g., 4 Rx). Shifting from the receiver mode 210-b and the receiver mode 210-a at the UE 115-a may be associated with some duration. The PDSCH 225 may be transmitted by the network entity 105-a during the duration, which may result in unsuccessful reception of the PDSCH 225 at the UE 115-a. That is, the PDSCH 225 may be transmitted too close to the PDCCH 220 if the UE 115-a may transition between receiver modes 210.

In other implementations, the UE 115-a may monitor for and receive the PDCCH 220 using an updated receiver mode 210, such as the receiver mode 210-a, rather than the receiver mode 210-b, based on reception of the WUS 215. In some cases, the UE 115-a may implement an LP-WUR 235 and a MR 240, as in signal processing diagram 230. For example, the MR 240 may be used for communication, such as transmitting signals, and may be associated with relatively high power consumption. The LP-WUR 235 may only allow for reception of signals and may operate to support lower power consumption. To transition from a low power mode to a normal mode, or to change from using the LP-WUR 235 to using the MR 240, the UE 115-a may monitor for the WUS 215, which may be an LP-WUS, using the LP-WUR 235. The UE 115-a may monitor for the WUS 215 during an MO. The network entity 105-a may transmit the WUS 215 to indicate to the UE 115-a that the UE 115-a may monitor for a PDCCH during a next PDCCH MO. The UE 115-a may save power when receiving the WUS 215 because the LP-WUR 235 hardware may be used to receive the WUS 215 (e.g., the LP-WUS) with very low power consumption. The UE 115-a may wake up the MR 240 after receiving the WUS 215, such that the MR 240 may monitor for (and receive) the PDCCH 220 and, in some cases, the PDSCH 225.

In some cases, the content or type of the PDCCH may depend on the connectivity state of the UE 115-a (e.g., paging PDCCH for an idle/inactive mode, data scheduling PDCCH for connected mode). In an idle or inactive mode (e.g., the UE 115-a may not be connected to the serving cell), the WUS 215 may trigger the UE 115-a to perform paging PDCCH monitoring. In a connected mode, the WUS 215 may trigger PDCCH monitoring in according with a discontinuous reception (DRX) cycle, which may support power saving. For example, the WUS 215 may trigger the UE 115-a to monitor for PDCCH during an upcoming DRX on-duration, inside a DRX active time, outside a DRX active time, or any combination thereof.

In some implementations, the WUS 215 may include an indication for the UE 115-a to switch between receiver modes 210. For example, the UE 115-a may receive the WUS 215 using the receiver mode 210-b, which may be an example of a receiver mode 210 with a low quantity of antennas 205 that may be activated at the UE 115-b. In some cases, the WUS 215 may be an LP-WUS received by the LP-WUR 235, and the LP-WUR 235 may wake up the MR 240 such as by sending an indication of the WUS 215 to the MR 240. The WUS 215 may indicate for the UE 115-a to switch to the receiver mode 210-a, which may be an example of a receiver mode 210 with a higher quantity of antennas 205. The UE 115-a may switch receiver modes 210 over some duration, which may be supported by a duration between the WUS 215 (e.g., LP-WUS) and a corresponding PDCCH MO, which may be a result of the UE 115-a switching from the LP-WUR 235 to the MR 240.

After switching receiver modes 210, the UE 115-a may monitor for a PDCCH 220. In some cases, the UE 115-a may receive the PDCCH 220, in accordance with the monitoring, via the antennas 205 in the receiver mode 210-a (e.g., antennas 205-a, 205-b, 205-c, and 205-d). In some cases, the PDCCH 220 may be received by the MR 240, based on the WUS 215 indicating to wake up the MR 240. In some cases, the PDCCH 220 may schedule a PDSCH 225. The UE 115-a may receive the PDSCH 225 with the receiver mode 210-a, associated with the greater quantity of antennas 205. Because the UE 115-a may have switched between receiver modes 210 before receiving the PDCCH 220, the UE 115-a may be able to successfully receive the PDSCH 225 with a requisite greater quantity of antennas 205 (e.g., receiver mode 210-a) without any delay associated with switching between receiver modes 210. That is, the UE 115-a may expend more power monitoring for the PDCCH 220 with the receiver mode 210-a, but may save power, reduce latency, and improve communications by eliminating a switch between receiver modes 210 after receiving the PDCCH 220 and before receiving the PDSCH 225. For example, including information about a quantity of antennas 205 via the WUS 215 may leverage the timing of the WUS 215, allowing the UE 115-a time to change receiver modes 210 without risking missing reception of a PDSCH 225.

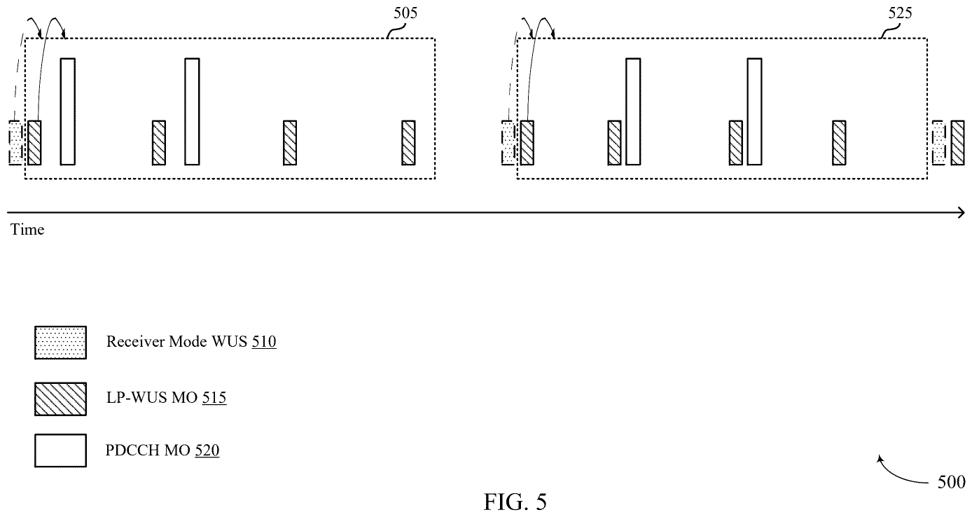

In some implementations, the WUS 215 may be an example of an LP-WUS. That is, the WUS 215 may be an LP-WUS that may include one or more bits indicating a quantity of antennas 205 or a receiver mode 210. In other implementations, the WUS 215 may be a WUS 215 (e.g., receiver mode 210 switch indication) sent specifically to indicate a change in the quantity of antennas 205. For example, the UE 115-a may monitor multiple PDCCH 220 MOs with a receiver mode 210. It may be power efficient to not change receiver modes 210, or there may be some other reason not to change receiver modes 210. However, the UE 115-a may still operate with a low power mode, such that the UE 115-a may enter a low power mode using the LP-WUR 235 after a PDCCH 220 MO. In some cases, the UE 115-a may receive an LP-WUS indicating to use the MR 240, but the UE 115-a may still operate with a receiver mode 210. Including an indication of the receiver mode 210 in the LP-WUS may be inefficient and may consume power for decoding extra information. Instead, a WUS 215 (e.g., receiver mode WUS) may be used, separately from the LP-WUS, to indicate a change in the receiver mode 210, as described further with reference to FIG. 5.

In some implementations, using a WUS 215 to trigger a switch between receiver modes 210 may reduce the power consumption of the UE 115-a. However, a WUS 215, such as an LP-WUS, may have lower reliability than other signaling, such as a PDCCH 220. For example, the WUS 215 may be a waveform-based signal, rather than a coding-based signal, which may lower the reliability of the WUS 215. In some cases, the UE 115-a may not decode the WUS 215 properly, which may result in failure to receive the PDSCH if the receiver mode 210 is not properly implemented (e.g., the gating effect). That is, the reliability of the WUS 215 may be important, and high-rank PDSCH 225 decoding failure may be inevitable if the WUS 215 is not decoded properly.

In some implementations, to address the lower reliability of the WUS 215, dual verification (e.g., DUO verification) of the receiver mode switch indication may be introduced with a DCI. For example, the PDCCH 220 may include a DCI message, and one or more bits of the DCI message may indicate the receiver mode switch. That is, the network entity 105-a may use one DCI bit to re-transmit the indication to switch between receiver modes 210. The UE 115-a may decode the DCI and if the DCI contains the same indication as the WUS 215, the UE 115-a may confirm the validity of the WUS 215. In some cases, the DCI and the WUS 215 may not agree. In this case, the UE 115-a may follow the indication of the DCI, which may have a higher reliability than the WUS 215. For example, the WUS may indicate to operate with receiver mode 210-b. The DCI, received via the PDCCH 220, may indicate to operate with receiver mode 210-a. The UE 115-a may switch to receiver mode 210-a based on the DCI.

Additionally, or alternatively, the network entity 105-a may mask the WUS 215 to improve the reliability by confirming the indication of the receiver mode switch, such as by designing a CRC mask. That is, the mask may confirm whether or not a switch between receiver modes 210 may have been indicated by the network entity 105-a. In some cases, the network entity 105-a may introduce additional scrambling of CRC bits in the WUS 215 in order to confirm the indicated switch between receiver modes 210. In some cases, the network entity 105-a may use CRC bits specifically for confirming the receiver mode 210 switch. That is, the network entity 105-a may use reserved CRC bits in the WUS 215 to indicate and confirm the switch between receiver modes 210. For example, a WUS 215 may include a quantity of CRC bits (e.g., 24 bits). A first quantity of CRC bits of the CRC bits attachment may be used to confirm the switch between receiver mode. All the CRC bits may be scrambled by a radio network temporary identifier (RNTI) associated with the connection between the network entity 105-a and the UE 115-a. Including a CRC mask may increase the reliability of the waveform for the WUS 215. In some cases, the CRC mask may not indicate the quantity of antennas 205 or the specific receiver mode 210. If the CRC mask indicates that the switch between the receiver modes 210 may not have been properly decoded or received from the WUS 215, the UE 115-a may default to using a receiver mode 210 that may implement a larger quantity of antennas 205 (e.g., receiver mode 210-a). This may help avoid potential PDSCH decoding failure. For example, the UE 115-a may determine that the WUS indicates for the UE 115-a to continue to use the receiver mode 210-b, used to receive the WUS 215, to monitor and receive the PDCCH. However, the CRC mask may indicate that the network entity 105-a did indicate a switch in receiver modes 210. The UE 115-a may default to receiver mode 210-a based on the difference between the indication in the WUS 215 and the CRC mask indication.

In some cases, the network entity 105-a may not have an indication of the receiver mode 210 that may be implemented at the UE 115-a. The network entity 105-a may operate as if the UE 115-a operates with a low quantity of antennas 205 for power saving, even if the UE 115-a may be operating with a greater quantity of antennas 205. For example, the network entity 105-a may transmit the WUS 215 assuming the UE 115-a is operating with receiver mode 210-b, where the WUS 215 may indicate for the UE 115-a to switch to receiver mode 210-a. The UE 115-a may receive the WUS 215 and may already be operating in the receiver mode 210-a. Therefore, the UE 115-a may not switch receiver modes 210. In some cases, the UE 115-a may automatically return to a receiver mode 210 that may use a lower quantity of antennas 205, such as the receiver mode 210-b. The UE 115-a may switch to the receiver mode 210 with the lower quantity of antennas 205 based on a timer or a window-based mechanism (e.g., a detection window, a monitoring window, an operating window). The network entity 105-a may assume the UE 115-a may operate according to the lower quantity of antennas 205 and may transmit the WUS 215 accordingly.

In some cases, the UE 115-a may autonomously determine to operate according to a receiver mode 210 with a higher quantity of antennas 205. That is, the UE 115-a may switch receiver modes 210 without receiving a WUS 215. The UE 115-a may indicate the switch to the network entity 105-a. In some examples, the UE 115-a may skip monitoring for the WUS 215, as an indication to change the receiver mode 210 to a receiver mode 210 using a higher quantity of antennas 205 may be redundant. The UE 115-a may transmit a message indicating the switch, that the UE 115-a may skip monitoring, or any combination thereof. In response, the network entity 105-a may not transmit the WUS 215 and may use the resource for the WUS 215 for another purpose.

FIG. 3 shows an example of a timing diagram 300 that supports receiver adaptations using WUSs in accordance with one or more aspects of the present disclosure. The timing diagram 300 may implement, or be implemented by, aspects of the wireless communications systems 100 and 200. The techniques described herein in the context of the timing diagram 300 may support indicating, via a WUS, to switch quantities of antennas at a UE.

In some implementations, as described with reference to FIG. 2, it may be beneficial to reduce a quantity of antennas in order to monitor a PDCCH to save power. For example, a UE may use a quantity of antennas 305 (e.g., 1 Rx) to monitor for a PDCCH at 325 and 330, and may receive the PDCCH with the quantity of antennas 305 at 335. The UE may then switch to the quantity of antennas 310 (e.g., 4 Rx, 8 Rx) at 340. Then, the UE may use the quantity of antennas 310 to receive the PDSCH at 350. However, the switch between the quantity of antennas 305 and the quantity of antennas 310 may not be instantaneous, and may instead be associated with some duration 345.

Additionally, or alternatively, the quantity of antennas employed at the UE may be dependent on a rank of a bandwidth part (BWP) being used by the UE. For example, a first BWP (e.g., BWP 1) may have a maximum rank of one, which may indicate the UE operates with one antenna. For example, the quantity of antennas 305 may be one for the first BWP. A second BWP (e.g., BWP 2) may be associated with a maximum rank of four. The UE may operate with four antennas for the second BWP. That is, the quantity of antennas 310 may be four for the second BWP. In some cases, BWP switching may used to switch the quantity of antennas. That is, a UE may switch BWP to switch from the quantity of antennas 305 to the quantity of antennas 310. The duration 345 associated with switching BWP may be high (e.g., greater than 2.5 ms), and may also include time for channel state information (CSI) measurements and reporting of CSI measurements and information. That is, switching between BWP based on restrictions on ranks for the BWP may be an option to implement a change in quantity of antennas at a UE, but may be time consuming and restrictive, since each BWP may be associated with a specific quantity of antennas.

In some cases, a UE may operate with a smaller quantity of antennas than indicated by the rank of a BWP. For example, a UE may use the second BWP with a rank of four. However, the UE may use the quantity of antennas 305, which may be one antenna, to monitor for the PDCCH at 325 and 330 and to receive the PDCCH at 335. However, a network entity may transmit the PDCCH as if the UE operated according to the BWP. That is, the network entity may schedule the PDCCH at 335 to be received with the quantity of antennas 310, and the UE may fail to decode the PDCCH received at 335 because the UE may operate with the quantity of antennas 305. Thus, the UE may send a NACK to the network entity to indicate the failure to decode the PDCCH and may switch to the quantity of antennas 310. The UE may then continue to monitor for a PDCCH, this time with the quantity of antennas 310. However, this may delay reception of the PDCCH and the subsequent reception of a PDSCH, increasing latency and power consumption at the UE. In some cases, the network entity may not retransmit the PDCCH and the UE may not receive the PDCCH.

In some implementations, a WUS, such as an LP-WUS may be implemented for the network entity to trigger a UE to monitor a PDCCH. That is, the UE may receive a WUS at 315, which may trigger to the UE to monitor for a PDCCH at 325. The WUS may be received with the quantity of antennas 305 (e.g., 1 Rx) and may include a duration 320 to shift between power modes (e.g., shifting from using an LP-WUR to using an MR). That is, the WUS may be received some duration 320 prior to a MO for the PDCCH (e.g., at 325). In some cases, the WUS may include an indication for the UE to switch between a quantity of antennas. Because the WUS already includes the duration 320 before the UE monitors for the PDCCH at 325, the UE may be able to transition between the quantity of antennas 305 and the quantity of antennas 310. This may resolve timeline issues associated with the duration 345 and decrease the chances of PDSCH decoding failure. In some examples, using the WUS to indicate a change in the quantity of antennas may also reduce power consumption based on reducing latency and the chances of unsuccessful PDSCH decoding.

Accordingly, it may be beneficial to support UE power saving for PDCCH monitoring by reducing a quantity of antennas, such as by using a quantity of antennas 305. For example, the UE may use the quantity of antennas 305 (e.g., 1 Rx, 2 Rx) to receive a PDCCH at 335 and may switch to the quantity of antennas 310 (e.g., 4 Rx, 8 Rx) at 340 to receive a PDSCH at 350 based on receiving the PDCCH at 335. The UE may do this by switching BWPs, which may be associated with high latency and a long duration 345, or by switching the quantity of antennas within a BWP, which may lead to undecodable PDCCH and PDSCH, as well as reducing power saving, reducing spectrum efficiency, and increasing latency, among other disadvantages. However, a WUS, such as an LP-WUS may be implemented for the network entity to trigger a UE to monitor a PDCCH. For example, the UE may receive a WUS at 315, which may trigger to the UE to monitor for a PDCCH at 325. The WUS may be received with the quantity of antennas 305 (e.g., 1 Rx) and may include a duration 320 to shift between power modes. For example, the WUS may be received some duration 320 prior to a MO for the PDCCH (e.g., at 325). This may introduce a longer transition time for the UE to switch between the quantity of antennas 305 and the quantity of antennas 310, which may resolve timeline issues. Thus, a WUS may be used to indicate a switch between different quantities of antennas, such as between the quantity of antennas 305 and the quantity of antennas 310. This may resolve timeline issues and may lower consumption based on reducing latency and the chances of unsuccessful PDSCH decoding.

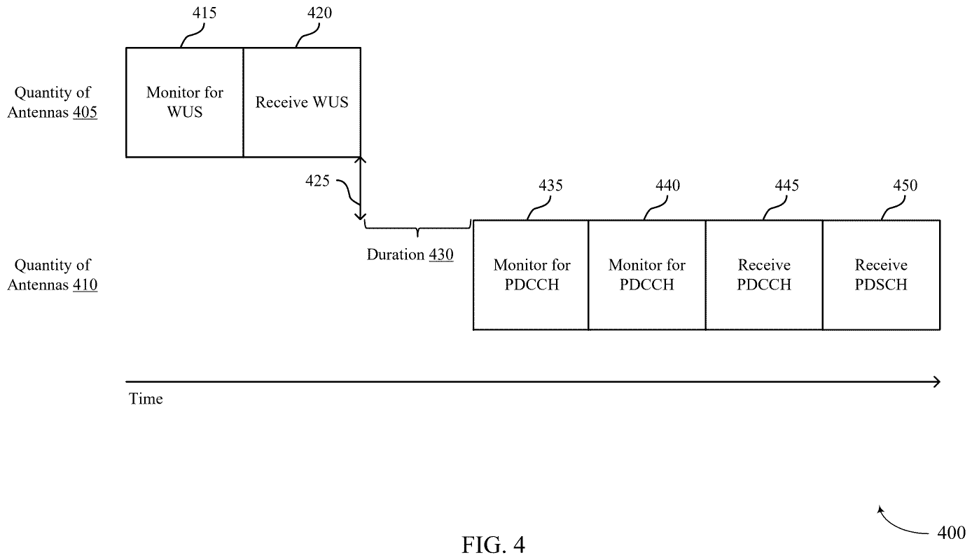

FIG. 4 shows an example of a timing diagram 400 that supports receiver adaptations using WUSs in accordance with one or more aspects of the present disclosure. The timing diagram 400 may implement, or be implemented by, aspects of the wireless communications systems 100 or 200, or timing diagram 300. The techniques described herein in the context of the timing diagram 400 may support a UE receiving a WUS to indicate a change in a quantity of antennas for PDCCH monitoring, reducing the risk of PDSCH decoding failure.

In some implementations, a UE may, with a quantity of antennas 405 (e.g., 1 Rx), monitor for a WUS at 415 and receive a WUS at 420. In some cases, the WUS may be an LP-WUS and may include one or more bits to indicate to switch from the quantity of antennas 405 and the quantity of antennas 410, as well as indicating to monitor for a PDCCH at 435. In some cases, a network entity may configure one or multiple sets of WUS, such as LP-WUS, around PDCCH MOs. In some examples, each LP-WUS may be associated with a specific search space for the UE to monitor for the PDCCH. A UE may use an LP-WUR to monitor for the WUS at 415. The UE may receive the WUS at 420, which may include an indication from the network entity pf whether one or more PDCCH MOs may include DCI that may schedule a high rank PDSCH. That is, the WUS may indicate that receiving the PDSCH at 450 may use the quantity of antennas 410, which may be greater than the quantity of antennas 405. In some examples, the indication may be an indication that triggers a receiver mode switch, or a switch between the different quantities of antennas.

At 425, the UE may switch from the quantity of antennas 405 to the quantity of antennas 410 in order to monitor the PDCCH at 435 and 440 based on receiving the WUS at 420 that may indicate to change the quantity of antennas. The switch may be associated with some duration 430 between receiving the WUS at 420 and monitoring for the PDCCH at 435. The duration 430 may provide the UE with time to switch between the quantity of antennas 405 and the quantity of antennas 410. If the WUS does not indicate for the UE to switch to the quantity of antennas 410 to monitor the PDCCH, the UE may monitor the PDCCH at 435 and 440 with the quantity of antennas 405. In some examples, the network entity may not expect to schedule a PDSCH with a high rank via a PDCCH in the associated PDCCH MOs, so the network entity may not indicate for the UE to switch quantities of antennas.

After the duration 430, if the WUS received at 420 indicates for the UE to switch to the quantity of antennas 410, the UE may monitor for a PDCCH at 435 and 440 using the quantity of antennas 410. At 445, the UE may receive the PDCCH, which may schedule a PDSCH. The UE may receive the PDSCH at 450. The UE may be able to receive the PDSCH at 450 directly after receiving the PDCCH at 445, as the UE may already be operating with the quantity of antennas 410. That is, there may be no duration associated with switching between quantities of antenna safter receiving the PDCCH, as described further at FIG. 3. In some examples, the UE may autonomously or automatically shift to a different receiver mode, as described further with reference to FIG. 2.

FIG. 5 shows an example of a signal diagram 500 that supports receiver adaptations using WUSs in accordance with one or more aspects of the present disclosure. The signal diagram 500 may implement, or be implemented by, aspects of the wireless communications systems 100 or 200, or timing diagrams 300 or 400. The techniques described herein in the context of the signal diagram 500 may support the network entity transmitting a WUS for indicating a receiver mode to a UE for the UE to use to monitor for a PDCCH.

In some implementations, as described with reference to FIG. 4, an indication to switch between receiver modes made be embedded into an LP-WUS 515 that may wake-up a UE for PDCCH MOs 520. However, in some cases, the UE may not frequently switch between quantities of antennas. Instead, the indication to switch quantities of antennas may be offloaded to a specific WUS, which may be a different LP-WUS (e.g., a receiver mode WUS 510). The receiver mode WUS 510, which may be received with an LP-WUR at the UE, may indicate whether the UE may switch receiver modes (e.g., quantities of antennas) when it is woken up in a time window, such as the time window 505 or 525. The LP-WUS 515 (e.g., the regular LP-WUS 515) may not include an indication to switch receiver modes (e.g., may not have bits reserved for a receiver mode switch indication). This may enhance the capacity of the LP-WUS 515 to support more UEs.

In some cases, the reduce signaling overhead and reduce monitoring at the UE, the receiver mode WUS 510 may be transmitted with a larger periodicity than the LP-WUS 515. The periodicity of the receiver mode WUS 510 may be related to the window 505 or 525. For example, the UE may receive the receiver mode WUS 510, which may indicate for the UE to maintain a receiver mode with a small quantity of antennas (e.g., 1 Rx, 2 Rx), for the duration of the window 505. Within the window 550, the UE may monitor for LP-WUSs 515 during the LP-WUS 515 MOs using the receiver mode indicated by the receiver mode WUS 510. If the UE receives an LP-WUS 515 in a LP-WUS 515 MO, the UE may monitor during a PDCCH MO 520. After the window 505, the UE may receive another receiver mode WUS 510, which may indicate for the UE to operate according to a new receiver mode (e.g., 4 Rx, 6 Rx, 8 Rx), and the UE may switch to the new receiver mode. Within the window 525, the UE may monitor for LP-WUS during the LP-WUS 515 MOs using the new receiver mode indicated by the receiver mode WUS 510. If the UE receive an LP-WUS in a LP-WUS 515 MO, the UE may monitor during a PDCCH MO 520.

In some examples, the receiver mode WUS 510 may not indicate for the UE to change radios. That is, the receiver mode WUS 510, received with the LP-WUR, may indicate for the UE to use a specific receiver mode. The LP-WUS 515 may indicate for the UE to switch radios. That is, the LP-WUS 515 may be received with the LP-WUR and may indicate for the UE to use a MR for PDCCH monitoring and reception. In some examples, the UE may autonomously or automatically shift to a different receiver mode, as described further with reference to FIG. 2. In some examples, switching receiver modes at the UE may be associated with the windows 505 and 525.

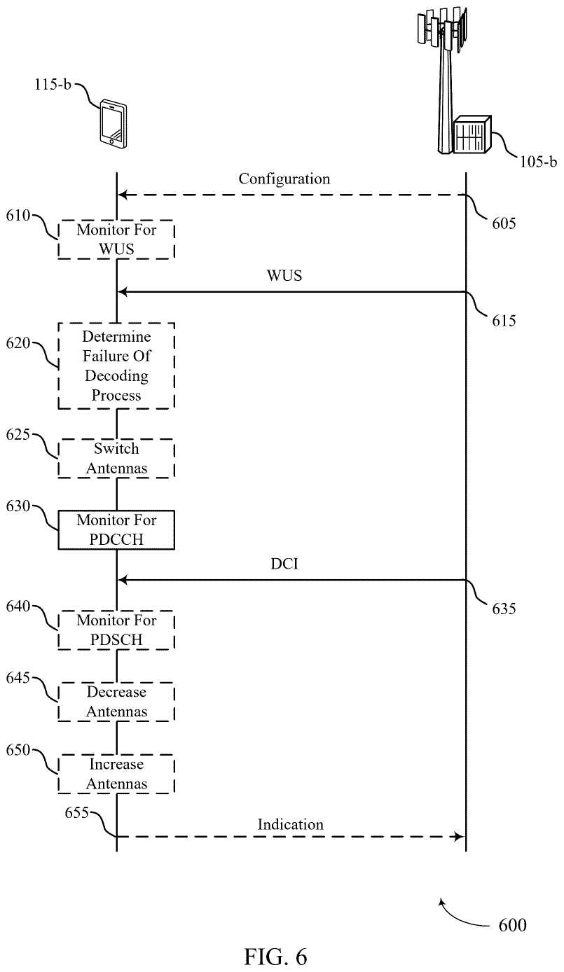

FIG. 6 shows an example of a process flow 600 that supports receiver adaptations using WUSs in accordance with one or more aspects of the present disclosure. The process flow 600 may implement, or be implemented by, aspects of the wireless communications systems 100 or 200, timing diagrams 300 or 400, or signal diagram 500. For example, the process flow 600 may include one or more network entities 105 and UEs 115, including at least the network entity 105-b and the UE 115-b, which may be examples of corresponding devices as described herein, including with reference to FIGS. 1 and 2. The techniques described herein in the context of the process flow 600 may support the network entity 105-b to transmit a WUS to indicate for the UE 115-b to change a quantity of antennas for PDCCH monitoring.

In some implementations, at 605, the UE 115-b may receive, and the network entity 105-b may output, one or more signals indicating a configuration for a WUS, where the configuration may indicate that the WUS includes an LP-WUS and where one or more bits of the LP-WUS indicate a quantity of antennas.

At 610, the UE 115-b may monitor, using a WUR (e.g., LP-WUR) of the UE 115-b and using a second quantity of antennas, for the WUS, where the second quantity of antennas may be less than the quantity of antennas, as described at 605.

At 615, the UE 115-b may receive, via the WUR of the UE 115-b, the WUS indicating the quantity of antennas for the UE 115-b to use to monitor for a downlink control channel (e.g., PDCCH) for the UE, as described at 630. In some cases, the quantity of antennas may be indicated based on receiving the one or more signals indicating the configuration for the WUS, as described at 605. In some cases, receiving the WUS may be based on monitoring for the WUS, as described at 610. In some cases, the WUS may include a receiver mode WUS, the receiver mode WUS dedicated for indicating the quantity of antennas, as described further with reference to FIG. 5. In some examples, the receiver mode WUS may be associated with a first periodicity, and the UE 115-b may receive an LP-WUS associated with a second periodicity, where the second periodicity may be less than the first periodicity.

In some implementations, at 620, the UE 115-b may determine a failure of a decoding process associated with the WUS. In some cases, the WUS may include one or more CRC bits that may indicate a switch from a second quantity of antennas to the quantity of antennas, or one or more scrambled CRC bits that may indicate the switch from the second quantity of antennas to the quantity of antennas, or any combination thereof. The UE 115-b may determine, based on the one or more CRC bits, the one or more scrambled CRC bits, or any combination thereof, failure of the decoding procedure associated with the WUS.

In some implementations, at 625, the UE 115-b may switch, based on reception of the WUS at 615 and during a switching duration, from operating using the second quantity of antennas, as described at 610, to operating using the quantity of antennas. In some cases, the UE 115-b may switch, based on the determination at 620, to a third quantity of antennas (e.g., second quantity of antennas), the third quantity of antennas greater than the quantity of antennas. That is, if the UE 115-b determines failure of a decoding process associated with the WUS at 620, the UE 115-b may increase the quantity of antennas for monitoring for a downlink shared channel and, in some cases, for monitoring for a downlink control channel, to reduce the chances of failing to receive the downlink shared channel.

At 630, the UE 115-b may monitor, using an MR of the UE 115-b, one or more control channel MOs (e.g., PDCCH MOs) for the downlink control channel (e.g., PDCCH) for the UE 115-b in accordance with the quantity of antennas indicated by the WUS at 615. In some cases, the UE 115-b may monitor for the downlink control channel using the second quantity of antennas based on the switching, as described at 625.

At 635, the UE 115-b may receive, based on monitoring the one or more control channel MOs, as described at 630, DCI via the downlink control channel, where the DCI is for a downlink shared channel (e.g., PDSCH) for the UE 115-b. In some cases, the DCI may indicate scheduling information for the downlink shared channel for the UE 115-b. Additionally, or alternatively, the DCI may indicate transmission formatting information, transmit power control (TPC) commands, resource availability information, power saving information, or any combination thereof. In some cases, the downlink shared channel may be associated with the quantity of antennas and the downlink control channel may be associated with a second quantity of antennas, where the second quantity of antennas may be less than the quantity of antennas. In some cases, the DCI may include an indication of a third quantity of antennas (e.g., second quantity of antennas) associated with the downlink shared channel. In some examples, the third quantity of antennas may be different from the quantity of antennas. The UE may monitor for the PDSCH, as described further at 640, in accordance with the DCI. For example, the UE may monitor for the PDSCH using the third quantity of antennas.

In some implementations, at 640, the UE 115-b may monitor for the downlink shared channel (e.g., PDSCH) based on receiving the DCI at 635. In some cases, the UE 115-b may monitor, using a MR of the UE 115-b and based on the DCI, as described at 635, one or more shared channel MOs for the downlink shared channel in accordance with the second quantity of antennas indicated by the DCI at 635. That is, if a quantity of antennas (e.g., the second quantity of antennas) indicated by the DCI received at 635 is different from the quantity of antennas indicated by the WUS at 615, the UE 115-b may monitor for the downlink share channel using the quantity indicated by the DCI at 635.

In some implementations, at 645, the UE 115-b may switch from the quantity of antennas to a second quantity of antennas in accordance with a timer, a detection window, or any combination thereof, wherein the second quantity of antennas is less than the quantity of antennas. That is, the UE 115-b may decrease a quantity of antennas at 645.

In some implementations, at 650, the UE 115-b may switch from the second quantity of antennas, as described at 645, to a third quantity of antennas in accordance with one or more conditions at the UE 115-b, where the third quantity of antennas may be greater than the second quantity of antennas. That is, the UE 115-b may increase a quantity of antennas at 650.

In some implementations, at 655, the UE 115-b may transmit, in accordance with the switch at 650, an indication that the UE is to skip one or more MOs for the WUS in accordance with switching to the third quantity of antennas.

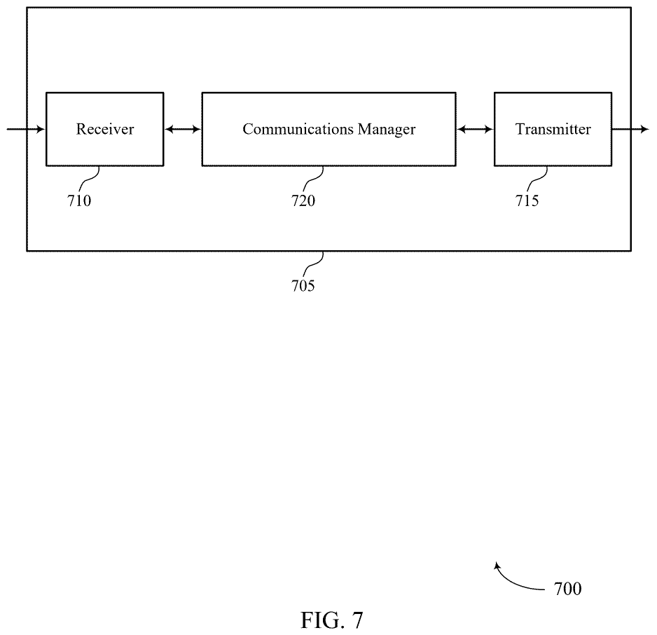

FIG. 7 shows a block diagram 700 of a device 705 that supports receiver adaptations using WUSs in accordance with one or more aspects of the present disclosure. The device 705 may be an example of aspects of a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to, individually or collectively, support or enable the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to receiver adaptations using WUSs). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to receiver adaptations using WUSs). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations or components thereof may be examples of means for performing various aspects of receiver adaptations using WUSs as described herein. For example, the communications manager 720, the receiver 710, the transmitter 715, or various combinations or components thereof may be capable of performing one or more of the functions described herein.

In some examples, the communications manager 720, the receiver 710, the transmitter 715, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 720, the receiver 710, the transmitter 715, or various combinations or components thereof may be implemented in code (e.g., as communications management software or firmware) executed by at least one processor (e.g., referred to as a processor-executable code). If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. For example, the communications manager 720 is capable of, configured to, or operable to support a means for receiving, via a WUR of the UE, a WUS indicating a quantity of antennas for the UE to use to monitor for a downlink control channel for the UE. The communications manager 720 is capable of, configured to, or operable to support a means for monitoring, using a MR of the UE, one or more control channel MOs for the downlink control channel for the UE in accordance with the quantity of antennas indicated by the WUS. The communications manager 720 is capable of, configured to, or operable to support a means for receiving, based on monitoring the one or more control channel MOs, DCI via the downlink control channel, where the DCI is for a downlink shared channel for the UE.

By including or configuring the communications manager 720 in accordance with examples as described herein, the device 705 (e.g., at least one processor controlling or otherwise coupled with the receiver 710, the transmitter 715, the communications manager 720, or a combination thereof) may support techniques for reduced processing, reduced power consumption, and more efficient utilization of communication resources.

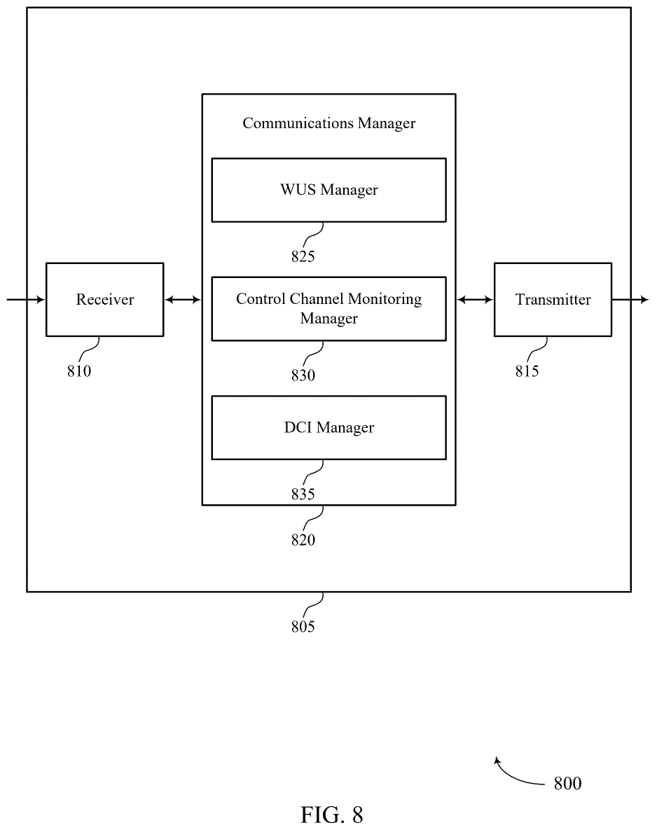

FIG. 8 shows a block diagram 800 of a device 805 that supports receiver adaptations using WUSs in accordance with one or more aspects of the present disclosure. The device 805 may be an example of aspects of a device 705 or a UE 115 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to support the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to receiver adaptations using WUSs). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to receiver adaptations using WUSs). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of receiver adaptations using WUSs as described herein. For example, the communications manager 820 may include a WUS manager 825, a control channel monitoring manager 830, a DCI manager 835, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. The WUS manager 825 is capable of, configured to, or operable to support a means for receiving, via a WUR of the UE, a WUS indicating a quantity of antennas for the UE to use to monitor for a downlink control channel for the UE. The control channel monitoring manager 830 is capable of, configured to, or operable to support a means for monitoring, using a MR of the UE, one or more control channel MOs for the downlink control channel for the UE in accordance with the quantity of antennas indicated by the WUS. The DCI manager 835 is capable of, configured to, or operable to support a means for receiving, based on monitoring the one or more control channel MOs, DCI via the downlink control channel, where the DCI is for a downlink shared channel for the UE.

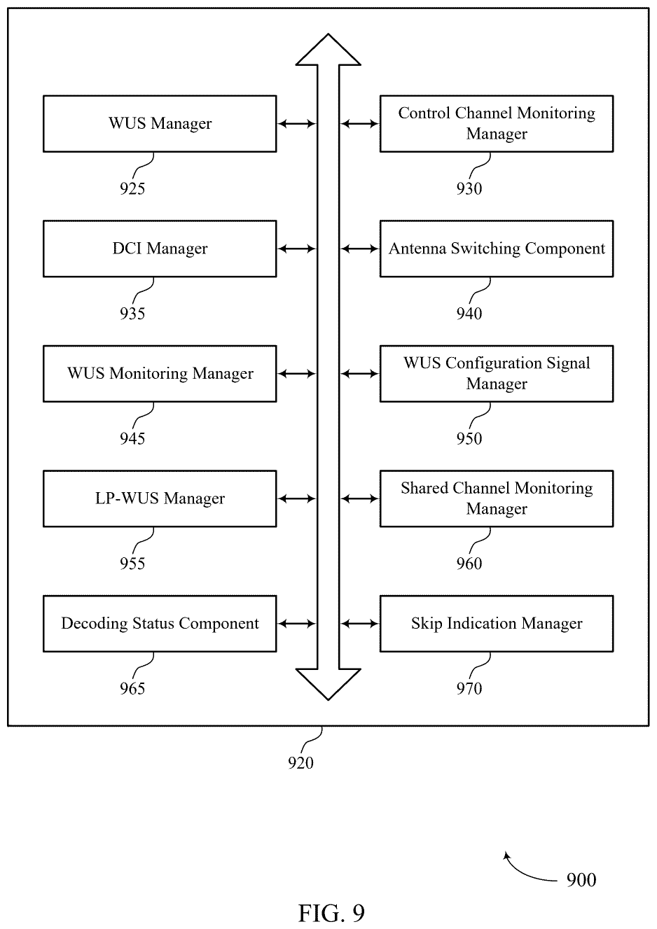

FIG. 9 shows a block diagram 900 of a communications manager 920 that supports receiver adaptations using WUSs in accordance with one or more aspects of the present disclosure. The communications manager 920 may be an example of aspects of a communications manager 720, a communications manager 820, or both, as described herein. The communications manager 920, or various components thereof, may be an example of means for performing various aspects of receiver adaptations using WUSs as described herein. For example, the communications manager 920 may include a WUS manager 925, a control channel monitoring manager 930, a DCI manager 935, an antenna switching component 940, a WUS monitoring manager 945, a WUS configuration signal manager 950, an LP-WUS manager 955, a shared channel monitoring manager 960, a decoding status component 965, a skip indication manager 970, or any combination thereof. Each of these components, or components or subcomponents thereof (e.g., one or more processors, one or more memories), may communicate, directly or indirectly, with one another (e.g., via one or more buses).

The communications manager 920 may support wireless communications in accordance with examples as disclosed herein. The WUS manager 925 is capable of, configured to, or operable to support a means for receiving, via a WUR of the UE, a WUS indicating a quantity of antennas for the UE to use to monitor for a downlink control channel for the UE. The control channel monitoring manager 930 is capable of, configured to, or operable to support a means for monitoring, using a MR of the UE, one or more control channel MOs for the downlink control channel for the UE in accordance with the quantity of antennas indicated by the WUS. The DCI manager 935 is capable of, configured to, or operable to support a means for receiving, based on monitoring the one or more control channel MOs, DCI via the downlink control channel, where the DCI is for a downlink shared channel for the UE.

In some examples, the antenna switching component 940 is capable of, configured to, or operable to support a means for switching, based on reception of the WUS and during a switching duration, from operating using a second quantity of antennas to operating using the quantity of antennas.

In some examples, the downlink shared channel is associated with the quantity of antennas and. In some examples, the downlink control channel is associated with a second quantity of antennas. In some examples, the second quantity of antennas is less than the quantity of antennas.

In some examples, monitoring, using the WUR of the UE and using a second quantity of antennas, for the WUS, where the second quantity of antennas is less than the quantity of antennas.

In some examples, the WUS configuration signal manager 950 is capable of, configured to, or operable to support a means for receiving one or more signals indicating a configuration for the WUS, where the configuration indicates that the WUS includes a LP-WUS, and where one or more bits of the LP-WUS indicate the quantity of antennas.

In some examples, the WUS includes a receiver mode WUS, the receiver mode WUS dedicated for indicating the quantity of antennas.

In some examples, the receiver mode WUS is associated with a first periodicity, and the LP-WUS manager 955 is capable of, configured to, or operable to support a means for receiving a LP-WUS associated with a second periodicity, where the second periodicity is less than the first periodicity.

In some examples, the DCI includes an indication of a second quantity of antennas associated with the downlink shared channel.

In some examples, the second quantity of antennas is different from the quantity of antennas, and the shared channel monitoring manager 960 is capable of, configured to, or operable to support a means for monitoring, using a MR of the UE and based on the DCI, one or more shared channel MOs for the downlink shared channel in accordance with the second quantity of antennas indicated by the DCI.

In some examples, the WUS includes one or more CRC bits indicating a switch from a second quantity of antennas to the quantity of antennas, or one or more scrambled CRC bits that indicate the switch from the second quantity of antennas to the quantity of antennas, or any combination thereof

In some examples, the decoding status component 965 is capable of, configured to, or operable to support a means for determining, based on the one or more CRC bits, the one or more scrambled CRC bits, or any combination thereof, failure of a decoding procedure associated with the WUS. In some examples, the antenna switching component 940 is capable of, configured to, or operable to support a means for switching, based on the determination, to a second quantity of antennas, the second quantity of antennas greater than the quantity of antennas.

In some examples, the antenna switching component 940 is capable of, configured to, or operable to support a means for switching from the quantity of antennas to a second quantity of antennas in accordance with a timer, a detection window, or any combination thereof, where the second quantity of antennas is less than the quantity of antennas.

In some examples, the antenna switching component 940 is capable of, configured to, or operable to support a means for switching from the second quantity of antennas to a third quantity of antennas in accordance with one or more conditions at the UE, where the third quantity of antennas is greater than the second quantity of antennas. In some examples, the skip indication manager 970 is capable of, configured to, or operable to support a means for transmitting, in accordance with the switch, an indication that the UE is to skip one or more MOs for the WUS in accordance with switching to the third quantity of antennas.

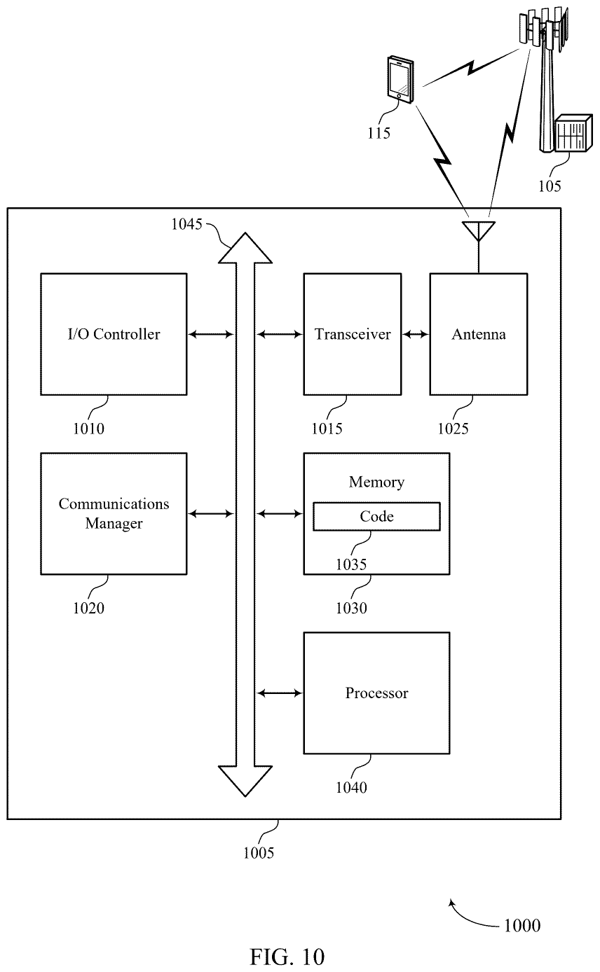

FIG. 10 shows a diagram of a system 1000 including a device 1005 that supports receiver adaptations using WUSs in accordance with one or more aspects of the present disclosure. The device 1005 may be an example of or include components of a device 705, a device 805, or a UE 115 as described herein. The device 1005 may communicate (e.g., wirelessly) with one or more other devices (e.g., network entities 105, UEs 115, or a combination thereof). The device 1005 may include components for bi-directional voice and data communications including components for transmitting and receiving communications, such as a communications manager 1020, an input/output (I/O) controller, such as an I/O controller 1010, a transceiver 1015, one or more antennas 1025, at least one memory 1030, code 1035, and at least one processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of one or more processors, such as the at least one processor 1040. In some cases, a user may interact with the device 1005 via the I/O controller 1010 or via hardware components controlled by the I/O controller 1010.

In some cases, the device 1005 may include a single antenna. However, in some other cases, the device 1005 may have more than one antenna, which may be capable of concurrently transmitting or receiving multiple wireless transmissions. The transceiver 1015 may communicate bi-directionally via the one or more antennas 1025 using wired or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The at least one memory 1030 may include random access memory (RAM) and read-only memory (ROM). The at least one memory 1030 may store computer-readable, computer-executable, or processor-executable code, such as the code 1035. The code 1035 may include instructions that, when executed by the at least one processor 1040, cause the device 1005 to perform various functions described herein. The code 1035 may be stored in a non-transitory computer-readable medium such as system memory or another type of memory. In some cases, the code 1035 may not be directly executable by the at least one processor 1040 but may cause a computer (e.g., when compiled and executed) to perform functions described herein. In some cases, the at least one memory 1030 may include, among other things, a basic I/O system (BIOS) which may control basic hardware or software operation such as the interaction with peripheral components or devices.

The at least one processor 1040 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1040 may be configured to operate a memory array using a memory controller. In some other cases, a memory controller may be integrated into the at least one processor 1040. The at least one processor 1040 may be configured to execute computer-readable instructions stored in a memory (e.g., the at least one memory 1030) to cause the device 1005 to perform various functions (e.g., functions or tasks supporting receiver adaptations using WUSs). For example, the device 1005 or a component of the device 1005 may include at least one processor 1040 and at least one memory 1030 coupled with or to the at least one processor 1040, the at least one processor 1040 and the at least one memory 1030 configured to perform various functions described herein.

In some examples, the at least one processor 1040 may include multiple processors and the at least one memory 1030 may include multiple memories. One or more of the multiple processors may be coupled with one or more of the multiple memories, which may, individually or collectively, be configured to perform various functions described herein. In some examples, the at least one processor 1040 may be a component of a processing system, which may refer to a system (such as a series) of machines, circuitry (including, for example, one or both of processor circuitry (which may include the at least one processor 1040) and memory circuitry (which may include the at least one memory 1030)), or components, that receives or obtains inputs and processes the inputs to produce, generate, or obtain a set of outputs. The processing system may be configured to perform one or more of the functions described herein. For example, the at least one processor 1040 or a processing system including the at least one processor 1040 may be configured to, configurable to, or operable to cause the device 1005 to perform one or more of the functions described herein. Further, as described herein, being “configured to,” being “configurable to,” and being “operable to” may be used interchangeably and may be associated with a capability, when executing code 1035 (e.g., processor-executable code) stored in the at least one memory 1030 or otherwise, to perform one or more of the functions described herein.

The communications manager 1020 may support wireless communications in accordance with examples as disclosed herein. For example, the communications manager 1020 is capable of, configured to, or operable to support a means for receiving, via a WUR of the UE, a WUS indicating a quantity of antennas for the UE to use to monitor for a downlink control channel for the UE. The communications manager 1020 is capable of, configured to, or operable to support a means for monitoring, using a MR of the UE, one or more control channel MOs for the downlink control channel for the UE in accordance with the quantity of antennas indicated by the WUS. The communications manager 1020 is capable of, configured to, or operable to support a means for receiving, based on monitoring the one or more control channel MOs, DCI via the downlink control channel, where the DCI is for a downlink shared channel for the UE.

By including or configuring the communications manager 1020 in accordance with examples as described herein, the device 1005 may support techniques for improved communication reliability, reduced latency, reduced power consumption, and more efficient utilization of communication resources.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the at least one processor 1040, the at least one memory 1030, the code 1035, or any combination thereof. For example, the code 1035 may include instructions executable by the at least one processor 1040 to cause the device 1005 to perform various aspects of receiver adaptations using WUSs as described herein, or the at least one processor 1040 and the at least one memory 1030 may be otherwise configured to, individually or collectively, perform or support such operations.

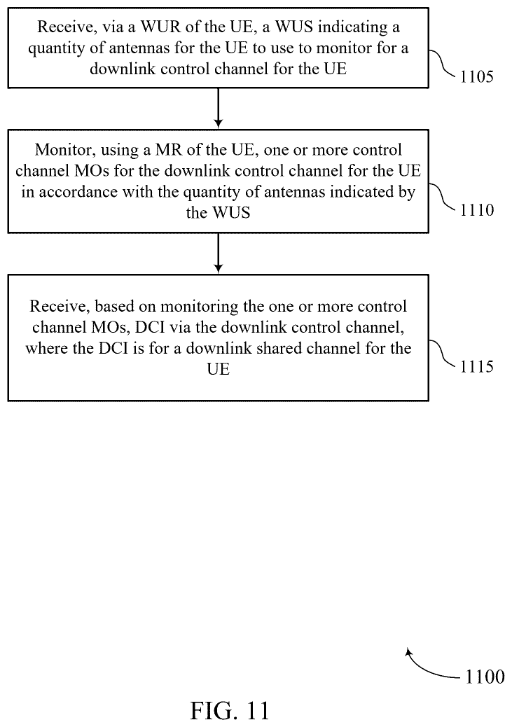

FIG. 11 shows a flowchart illustrating a method 1100 that supports receiver adaptations using WUSs in accordance with one or more aspects of the present disclosure. The operations of the method 1100 may be implemented by a UE or its components as described herein. For example, the operations of the method 1100 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1105, the method may include receiving, via a WUR of the UE, a WUS indicating a quantity of antennas for the UE to use to monitor for a downlink control channel for the UE. The operations of 1105 may be performed in accordance with examples as disclosed herein. In some examples, aspects of the operations of 1105 may be performed by a WUS manager 925 as described with reference to FIG. 9.

At 1110, the method may include monitoring, using a MR of the UE, one or more control channel MOs for the downlink control channel for the UE in accordance with the quantity of antennas indicated by the WUS. The operations of 1110 may be performed in accordance with examples as disclosed herein. In some examples, aspects of the operations of 1110 may be performed by a control channel monitoring manager 930 as described with reference to FIG. 9.

At 1115, the method may include receiving, based on monitoring the one or more control channel MOs, DCI via the downlink control channel, where the DCI may be for a downlink shared channel for the UE. The operations of 1115 may be performed in accordance with examples as disclosed herein. In some examples, aspects of the operations of 1115 may be performed by a DCI manager 935 as described with reference to FIG. 9.

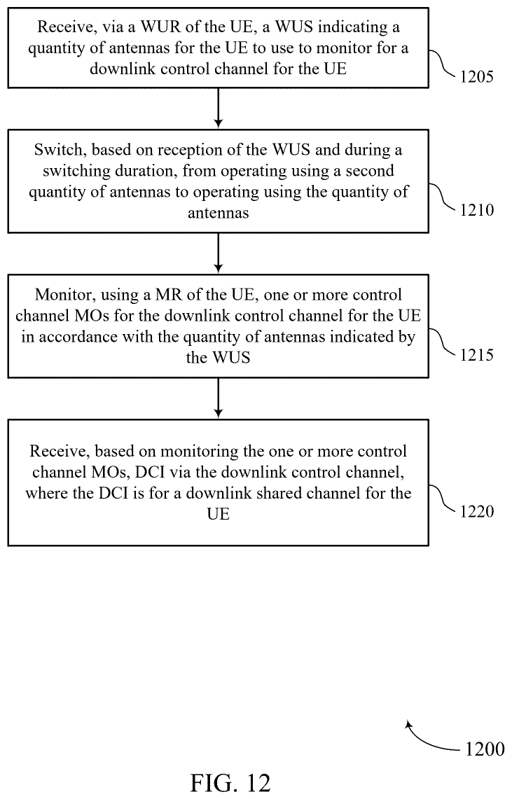

FIG. 12 shows a flowchart illustrating a method 1200 that supports receiver adaptations using WUSs in accordance with one or more aspects of the present disclosure. The operations of the method 1200 may be implemented by a UE or its components as described herein. For example, the operations of the method 1200 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1205, the method may include receiving, via a WUR of the UE, a WUS indicating a quantity of antennas for the UE to use to monitor for a downlink control channel for the UE. The operations of 1205 may be performed in accordance with examples as disclosed herein. In some examples, aspects of the operations of 1205 may be performed by a WUS manager 925 as described with reference to FIG. 9.

At 1210, the method may include switching, based on reception of the WUS and during a switching duration, from operating using a second quantity of antennas to operating using the quantity of antennas. The operations of 1210 may be performed in accordance with examples as disclosed herein. In some examples, aspects of the operations of 1210 may be performed by an antenna switching component 940 as described with reference to FIG. 9.

At 1215, the method may include monitoring, using a MR of the UE, one or more control channel MOs for the downlink control channel for the UE in accordance with the quantity of antennas indicated by the WUS. The operations of 1215 may be performed in accordance with examples as disclosed herein. In some examples, aspects of the operations of 1215 may be performed by a control channel monitoring manager 930 as described with reference to FIG. 9.

At 1220, the method may include receiving, based on monitoring the one or more control channel MOs, DCI via the downlink control channel, where the DCI may be for a downlink shared channel for the UE. The operations of 1220 may be performed in accordance with examples as disclosed herein. In some examples, aspects of the operations of 1220 may be performed by a DCI manager 935 as described with reference to FIG. 9.

The following provides an overview of aspects of the present disclosure:

Aspect 1: A method for wireless communications at UE, comprising: receiving, via a WUR of the UE, a WUS indicating a quantity of antennas for the UE to use to monitor for a downlink control channel for the UE; monitoring, using a MR of the UE, one or more control channel MOs for the downlink control channel for the UE in accordance with the quantity of antennas indicated by the WUS; and receiving, based at least in part on monitoring the one or more control channel MOs, WUS via the downlink control channel, wherein the WUS is for a downlink shared channel for the UE.

Aspect 2: The method of aspect 1, further comprising: switching, based at least in part on reception of the WUS and during a switching duration, from operating using a second quantity of antennas to operating using the quantity of antennas.

Aspect 3: The method of any of aspects 1 through 2, wherein the downlink shared channel is associated with the quantity of antennas and the downlink control channel is associated with a second quantity of antennas, the second quantity of antennas is less than the quantity of antennas.

Aspect 4: The method of any of aspects 1 through 3, further comprising: monitoring, using the WUR of the UE and using a second quantity of antennas, for the WUS, wherein the second quantity of antennas is less than the quantity of antennas.

Aspect 5: The method of any of aspects 1 through 4, further comprising: receiving one or more signals indicating a configuration for the WUS, wherein the configuration indicates that the WUS comprises a LP-WUS, and wherein one or more bits of the LP-WUS indicate the quantity of antennas.

Aspect 6: The method of any of aspects 1 through 4, wherein the WUS comprises a receiver mode WUS, the receiver mode WUS dedicated for indicating the quantity of antennas.

Aspect 7: The method of aspect 6, wherein the receiver mode WUS is associated with a first periodicity, and the method further comprising: receiving a LP-WUS associated with a second periodicity, wherein the second periodicity is less than the first periodicity.

Aspect 8: The method of any of aspects 1 through 7, wherein the WUS comprises an indication of a second quantity of antennas associated with the downlink shared channel.

Aspect 9: The method of aspect 8, wherein the second quantity of antennas is different from the quantity of antennas, and the method further comprising: monitoring, using a MR of the UE and based at least in part on the WUS, one or more shared channel MOs for the downlink shared channel in accordance with the second quantity of antennas indicated by the WUS.

Aspect 10: The method of any of aspects 1 through 9, wherein the WUS includes one or more CRC bits indicating a switch from a second quantity of antennas to the quantity of antennas, or one or more scrambled CRC bits that indicate the switch from the second quantity of antennas to the quantity of antennas, or any combination thereof.

Aspect 11: The method of aspect 10, further comprising: determining, based at least in part on the one or more CRC bits, the one or more scrambled CRC bits, or any combination thereof, failure of a decoding procedure associated with the WUS; and switching, based at least in part on the determination, to a second quantity of antennas, the second quantity of antennas greater than the quantity of antennas.

Aspect 12: The method of any of aspects 1 through 11, further comprising: switching from the quantity of antennas to a second quantity of antennas in accordance with a timer, a detection window, or any combination thereof, wherein the second quantity of antennas is less than the quantity of antennas.

Aspect 13: The method of aspect 12, further comprising: switching from the second quantity of antennas to a third quantity of antennas in accordance with one or more conditions at the UE, wherein the third quantity of antennas is greater than the second quantity of antennas; and transmitting, in accordance with the switch, an indication that the UE is to skip one or more MOs for the WUS in accordance with switching to the third quantity of antennas.

Aspect 14: A UE for wireless communications, comprising one or more memories storing processor-executable code, and one or more processors coupled with the one or more memories and individually or collectively operable to execute the code to cause the UE to perform a method of any of aspects 1 through 13.

Aspect 15: A UE for wireless communications, comprising at least one means for performing a method of any of aspects 1 through 13.

Aspect 16: A non-transitory computer-readable medium storing code for wireless communications, the code comprising instructions executable by one or more processors to perform a method of any of aspects 1 through 13.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive, via a wake up radio of the UE, a wake up signal indicating a quantity of antennas for the UE to use to monitor for a downlink control channel for the UE;
monitor, using a main radio of the UE, one or more control channel monitoring occasions for the downlink control channel for the UE in accordance with the quantity of antennas indicated by the wake up signal; and
receive, based at least in part on monitoring the one or more control channel monitoring occasions, downlink control information via the downlink control channel, wherein the downlink control information is for a downlink shared channel for the UE.

2. The UE of claim 1, wherein the one or more processors are individually or collectively further operable to execute the code to cause the UE to:
switch, based at least in part on reception of the wake up signal and during a switching duration, from operating using a second quantity of antennas to operating using the quantity of antennas.

3. The UE of claim 1, wherein the downlink shared channel is associated with the quantity of antennas and wherein the downlink control channel is associated with a second quantity of antennas, wherein the second quantity of antennas is less than the quantity of antennas.

4. The UE of claim 1, wherein the one or more processors are individually or collectively further operable to execute the code to cause the UE to:
monitor, using the wake up radio of the UE and using a second quantity of antennas, for the wake up signal, wherein the second quantity of antennas is less than the quantity of antennas.

5. The UE of claim 1, wherein the one or more processors are individually or collectively further operable to execute the code to cause the UE to:
receive one or more signals indicating a configuration for the wake up signal, wherein the configuration indicates that the wake up signal comprises a low power-wake up signal, and wherein one or more bits of the low power-wake up signal indicate the quantity of antennas.

6. The UE of claim 1, wherein the wake up signal comprises a receiver mode wake up signal, the receiver mode wake up signal dedicated for indicating the quantity of antennas.

7. The UE of claim 6, wherein the receiver mode wake up signal is associated with a first periodicity, and the one or more processors are individually or collectively further operable to execute the code to cause the UE to:
receive a low power-wake up signal associated with a second periodicity, wherein the second periodicity is less than the first periodicity.

8. The UE of claim 1, wherein the downlink control information comprises an indication of a second quantity of antennas associated with the downlink shared channel.

9. The UE of claim 8, wherein the second quantity of antennas is different from the quantity of antennas, and the one or more processors are individually or collectively further operable to execute the code to cause the UE to:
monitor, using a main radio of the UE and based at least in part on the downlink control information, one or more shared channel monitoring occasions for the downlink shared channel in accordance with the second quantity of antennas indicated by the downlink control information.

10. The UE of claim 1, wherein the wake up signal includes one or more cyclic redundancy check bits indicating a switch from a second quantity of antennas to the quantity of antennas, or one or more scrambled cyclic redundancy check bits that indicate the switch from the second quantity of antennas to the quantity of antennas, or any combination thereof.

11. The UE of claim 10, wherein the one or more processors are individually or collectively further operable to execute the code to cause the UE to:
determine, based at least in part on the one or more cyclic redundancy check bits, the one or more scrambled cyclic redundancy check bits, or any combination thereof, failure of a decoding procedure associated with the wake up signal; and
switch, based at least in part on the determination, to a second quantity of antennas, the second quantity of antennas greater than the quantity of antennas.

12. The UE of claim 1, wherein the one or more processors are individually or collectively further operable to execute the code to cause the UE to:
switch from the quantity of antennas to a second quantity of antennas in accordance with a timer, a detection window, or any combination thereof, wherein the second quantity of antennas is less than the quantity of antennas.

13. The UE of claim 12, wherein the one or more processors are individually or collectively further operable to execute the code to cause the UE to:
switch from the second quantity of antennas to a third quantity of antennas in accordance with one or more conditions at the UE, wherein the third quantity of antennas is greater than the second quantity of antennas; and
transmit, in accordance with the switch, an indication that the UE is to skip one or more monitoring occasions for the wake up signal in accordance with switching to the third quantity of antennas.

14. A method for wireless communications at user equipment (UE), comprising:
receiving, via a wake up radio of the UE, a wake up signal indicating a quantity of antennas for the UE to use to monitor for a downlink control channel for the UE;
monitoring, using a main radio of the UE, one or more control channel monitoring occasions for the downlink control channel for the UE in accordance with the quantity of antennas indicated by the wake up signal; and
receiving, based at least in part on monitoring the one or more control channel monitoring occasions, downlink control information via the downlink control channel, wherein the downlink control information is for a downlink shared channel for the UE.

15. The method of claim 14, further comprising:
switching, based at least in part on reception of the wake up signal and during a switching duration, from operating using a second quantity of antennas to operating using the quantity of antennas.

16. The method of claim 14, wherein the downlink shared channel is associated with the quantity of antennas and wherein the downlink control channel is associated with a second quantity of antennas, wherein the second quantity of antennas is less than the quantity of antennas.

17. The method of claim 14, further comprising:
monitoring, using the wake up radio of the UE and using a second quantity of antennas, for the wake up signal, wherein the second quantity of antennas is less than the quantity of antennas.

18. The method of claim 14, further comprising:
receiving one or more signals indicating a configuration for the wake up signal, wherein the configuration indicates that the wake up signal comprises a low power-wake up signal, and wherein one or more bits of the low power-wake up signal indicate the quantity of antennas.

19. The method of claim 14, wherein the wake up signal comprises a receiver mode wake up signal, the receiver mode wake up signal dedicated for indicating the quantity of antennas.

20. The method of claim 19, wherein the receiver mode wake up signal is associated with a first periodicity, the method further comprising:
receiving a low power-wake up signal associated with a second periodicity, wherein the second periodicity is less than the first periodicity.

21. The method of claim 14, wherein the downlink control information comprises an indication of a second quantity of antennas associated with the downlink shared channel.

22. The method of claim 21, wherein the second quantity of antennas is different from the quantity of antennas, the method further comprising:
monitoring, using a main radio of the UE and based at least in part on the downlink control information, one or more shared channel monitoring occasions for the downlink shared channel in accordance with the second quantity of antennas indicated by the downlink control information.

23. The method of claim 14, wherein the wake up signal includes one or more cyclic redundancy check bits indicating a switch from a second quantity of antennas to the quantity of antennas, or one or more scrambled cyclic redundancy check bits that indicate the switch from the second quantity of antennas to the quantity of antennas, or any combination thereof.

24. The method of claim 23, further comprising:
determining, based at least in part on the one or more cyclic redundancy check bits, the one or more scrambled cyclic redundancy check bits, or any combination thereof, failure of a decoding procedure associated with the wake up signal; and
switching, based at least in part on the determination, to a second quantity of antennas, the second quantity of antennas greater than the quantity of antennas.

25. The method of claim 14, further comprising:
switching from the quantity of antennas to a second quantity of antennas in accordance with a timer, a detection window, or any combination thereof, wherein the second quantity of antennas is less than the quantity of antennas.

26. The method of claim 25, further comprising:
switching from the second quantity of antennas to a third quantity of antennas in accordance with one or more conditions at the UE, wherein the third quantity of antennas is greater than the second quantity of antennas; and
transmitting, in accordance with the switch, an indication that the UE is to skip one or more monitoring occasions for the wake up signal in accordance with switching to the third quantity of antennas.

27. A non-transitory computer-readable medium storing code for wireless communications, the code comprising instructions executable by one or more processors to:
receive, via a wake up radio of a user equipment (UE), a wake up signal indicating a quantity of antennas for the UE to use to monitor for a downlink control channel for the UE;
monitor, using a main radio of the UE, one or more control channel monitoring occasions for the downlink control channel for the UE in accordance with the quantity of antennas indicated by the wake up signal; and
receive, based at least in part on monitoring the one or more control channel monitoring occasions, downlink control information via the downlink control channel, wherein the downlink control information is for a downlink shared channel for the UE.

28. The non-transitory computer-readable medium of claim 27, wherein the instructions are further executable by the one or more processors to:
switch, based at least in part on reception of the wake up signal and during a switching duration, from operating using a second quantity of antennas to operating using the quantity of antennas.

29. The non-transitory computer-readable medium of claim 27, wherein the downlink shared channel is associated with the quantity of antennas and wherein the downlink control channel is associated with a second quantity of antennas, wherein the second quantity of antennas is less than the quantity of antennas.

30. The non-transitory computer-readable medium of claim 27, wherein the instructions are further executable by the one or more processors to:
monitor, using the wake up radio of the UE and using a second quantity of antennas, for the wake up signal, wherein the second quantity of antennas is less than the quantity of antennas.
